(19) United States
(12) Patent Application Publication
(10) Pub. No.: US 2023/0417780 A1
(43) Pub. Date: Dec. 28, 2023

(54) Biological Indicator Reader System

(71) Applicant: Advanced Sterilization Products, Inc., Irvine, CA (US)

(72) Inventors: Jacob Childs, Huntington Beach, CA (US); Darius D. Eghbal, Oakland, CA (US)

(73) Assignee: Advanced Sterilization Products, Inc., Irvine, CA (US)

(21) Appl. No.: 18/037,263

(22) PCT Filed: Nov. 15, 2021
(86) PCT No.: PCT/IB2021/060559

§ 371 Date: May 16, 2023

Related U.S. Application Data
(60) Provisional application No. 63/114,631, filed on Nov. 17, 2020.

(51) Int. Cl. G01N 35/00; B01L 9/00

(52) U.S. Cl. CPC G01N 35/00623; G01N 35/00732; B01L 9/56; G01N 2035/00752; G01N 2035/0091; G01N 2035/00376; G01N 2035/00831

(57) ABSTRACT

A biological indicator reader system (100) may comprise a standalone computing device (110) comprising a standalone reading system (140) and a graphical user interface (112) (e.g., a graphical touchscreen interface) that communicates with at least one incubator unit (130). The at least one incubator unit (130) may comprise a plurality of wells (132) that accommodate vials (134) as well as a display (136). The display may display information (e.g., an identification of a number of wells connected to the standalone computing device) that is also displayed on the graphical user interface (112) of the standalone computing device (110). The display (136) may be configured to show which well (132) has a vial (134) inserted therein and, additionally or alternatively, to indicate a test result in front of each respective well (132) of a test performed on the vial (134). Further, the at least one incubator unit (130) may comprise plural incubator units, which themselves comprise modular components. The plural incubator units may be connected to each other, e.g., in a daisy chain configuration.

### FIELD

The subject matter disclosed herein relates to a biological indicator reader system and, more specifically, a modular system for testing biological material stored in a biological indicator ampule.

### BACKGROUND

Vapor-based sterilization techniques require complex equipment to perform and test the sterilization process. For example the STERRAD® System, STERRAD® NX System or STERRAD® 100NX System of Advanced Sterilization Products, Inc. of Irvine California, are examples of sterilization systems, or sterilizers, that vaporize hydrogen peroxide and operate at low pressures, e.g., less than 200 millitorr. These complex equipment are a critical to hospitals and other healthcare facilities, as well as medical research facilities.

For example, a central sterile services department (CSSD) environment is a critical function in the healthcare industry such as hospitals and other health care facilities. The CSSD environment includes instruments, devices and equipment capable of sterilization of biological material and the testing of such sterilized biological material. The instruments used in the CSSD environment typically have a long use life (e.g., 8+ years); however, coupled with rapid development of technology, the instruments can be become outdated very quickly. Moreover, these instruments, devices and equipment typically have limited space and cannot easily scale up without having to purchase separate systems.

### SUMMARY OF THE DISCLOSURE

A biological indicator reader system may comprise a standalone computing device comprising a graphical user interface (e.g., a graphical touchscreen interface), a stand that supports the standalone computing device, a standalone reading system (e.g., a barcode reader) that communicates with the standalone computing device, and at least one incubator unit. The incubator unit may comprise a plurality of wells that accommodate vials as well as a display. The display may display information (e.g., an identification of a number of wells connected to the standalone computing device) that is also displayed on the graphical user interface of the standalone computing device.

The standalone computing device may also comprise a modular component that is replaceable without a need to replace the stand, the standalone reading system or the at least one incubator unit. The standalone computing device may also comprise a plurality of connection ports to connect the graphical user interface to the at least one incubator unit and the standalone reading system.

Further, the at least one incubator unit comprises a modular component that is replaceable without a need to replace the stand, the standalone reading system or the standalone computing device. The wells of the at least one incubator unit may be oriented in a horizontal row with the display in front of the horizontal row. Sensors may be associated with each of the wells and be configured to determine that the vials are inserted into the wells. The display may be configured to show which well has a vial inserted therein and, additionally or alternatively, to indicate a test result in front of each respective well of a test performed on the vial.

Additionally, the at least one incubator unit may comprise plural incubator units, which themselves comprise modular components. The plural incubator units may be connected in a daisy chain configuration. The plural incubator units and the standalone computing device may be configured to recognize a number of wells connected to the standalone computing device.

### BRIEF DESCRIPTION OF THE DRAWINGS

While the specification concludes with claims, which particularly point out and distinctly claim the subject matter described herein, it is believed the subject matter will be better understood from the following description of certain examples taken in conjunction with the accompanying drawings, in which like reference numerals identify the same elements and in which:

FIG. 1 depicts a perspective view of a biological indicator reader system;

FIG. 2 depicts a perspective view of a display/computing device used with the biological indicator reader system of FIG. 1;

FIG. 3 depicts a perspective view of a stand used with biological indicator reader system of FIG. 1;

FIG. 4 depicts a perspective view of an incubator unit used with biological indicator reader system of FIG. 1;

FIG. 5 depicts a perspective view of a biological indicator reader system with multiple incubator units; and

FIG. 6 is an illustrative architecture of the display/computing device of FIG. 2.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±10% of the recited value, e.g. “about 90%” may refer to the range of values from 81% to 99%. In addition, as used herein, the terms “patient,” “host,” “user,” and “subject” refer to any human or animal subject and are not intended to limit the systems or methods to human use, although use of the subject invention in a human patient represents a preferred embodiment.

The subject matter disclosed herein relates to a biological indicator reader system and, more specifically, a modular system for testing biological material stored in a biological indicator ampule. In specific aspects described herein, the biological indicator reader system can be used to determine proper sterilization of biological material stored in a biological indicator ampule, e.g., vial.

The biological indicator reader system described herein is a modular system which allows for upgrading parts of a system without having to replace the entire system. For example, the modular nature of the biological indicator reader system allows for easy upgradability due to rapid technological advances. Furthermore, the biological indicator reader system allows CSSDs that require larger capacity of incubation wells to scale up their system without having to purchase separate systems, thereby significantly decreasing overhead costs. Moreover, with the addition of connected device environments, the biological indicator reader system allows for a single system to communicate with a network and manage many biological indicators, e.g., incubator units, as compared to having separate integrated systems, which have the burden of coordinating information relating to the control of biological indicator usage and biological indicators being run on various sterilizers.

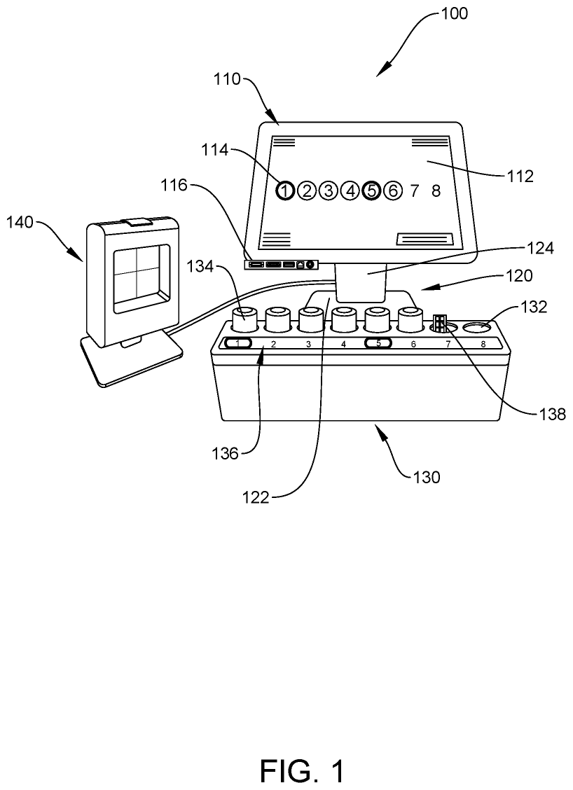

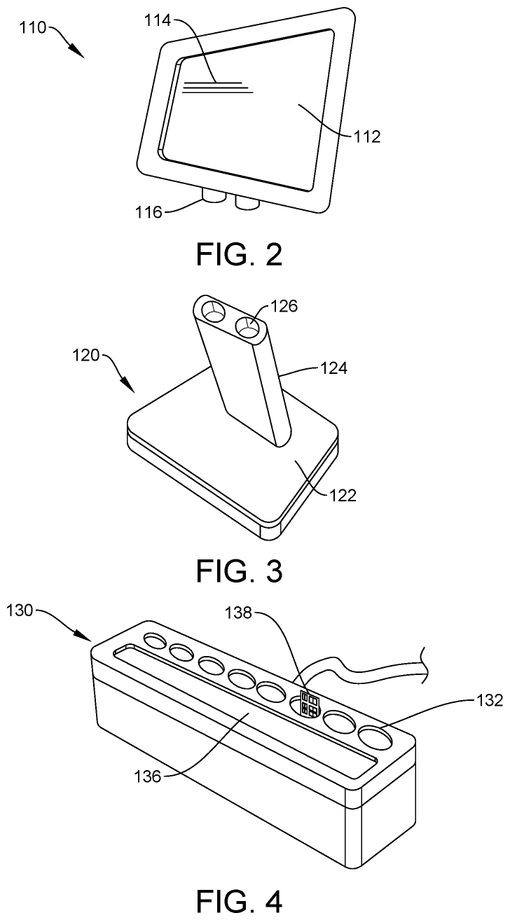

FIGS. 1-4 depict perspective views of a biological indicator reader system 100 and its modular components. More specifically, FIG. 1 shows modular components of biological indicator reader system 100 connected together to form a single, integrated system. This integrated system is capable of being scaled to different capacities, as well as having components which are replaceable due to failure of any of the components, or requirements of hardware upgrades. FIG. 2 depicts a standalone display/computing device 110 used with biological indicator reader system 100. FIG. 3 depicts a stand 120 that supports display/computing device 110 and FIG. 4 depicts an incubator unit 130 used with biological indicator reader system 100.

Referring to FIGS. 1 and 2, biological indicator reader system 100 includes a standalone display/computing device 110. Display/computing device 110 is a modular component which can easily be replaced with a newer version should the display/computing device 110 become outdated or some functionality requires updating, without the need to replace any of the other components of the biological indicator reader system 100.

Display/computing device 110 includes a graphical user interface 112. Graphical user interface 112 can be any graphical user interface 112 that is compatible with the remaining modular and replaceable components 120, 130, 140 shown in FIGS. 1-4. For example, graphical user interface 112 can be an organic light emitting-diode (OLED), a liquid crystal display (LCD), light-emitting diode display (LED), active-matrix organic light-emitting diode display (AMOLED), quantum dot light emitting diode display (QLED), plasma display or electroluminescent display (ELD), amongst other types of displays.

Graphical user interface 112 comprises a touchscreen interface that allows the user to select and view certain information on the interface. For example, information may include insignia 114 which correspond to respective heating wells 132 of incubator unit 130 as described in more detail below. The insignia 114 can be numbers, letters, alphanumerical codes, colors, etc. Graphical user interface 112 can include additional information such as operator identification (e.g., name, etc.), test results of biological matter, identification of biological indicator ampules 134 (e.g., vials) as read or scanned by standalone reading system 140, e.g., barcode scanner, in addition to other information required by biological indicator reader system 100 as is known in the art such that no further explanation is required for an understanding of the present disclosure.

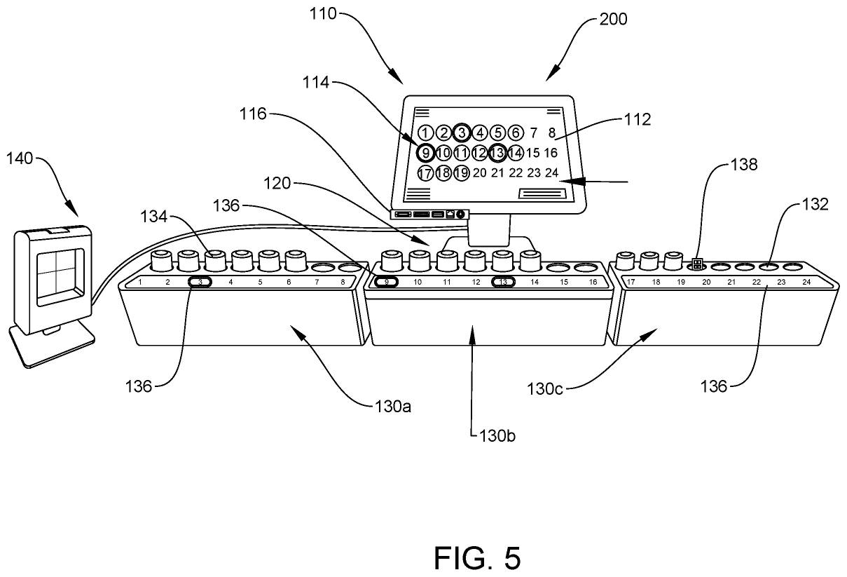

Display/computing device 110 further includes connection ports 116 to connect different modular components 130, 140 to graphical user interface 112. For example, connection ports 116 are used to connect together graphical user interface 112 with incubator unit 130 and reading system 140. Additional connection ports 116 can be provided to accommodate additional components such as additional incubator units 130a, 130b, 130c shown in FIG. 5. Additionally or alternatively, modular components 130, 140 can be connected to display/computing device 110 through wireless connections. These wireless connections can be Wi-Fi, Bluetooth, technologies, or other short-range wireless communications that replace the cables connecting to display/computing device 110.

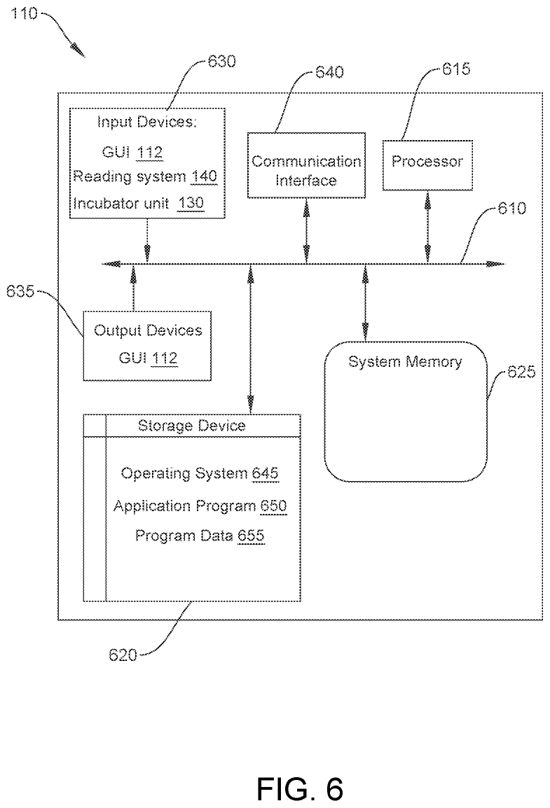

Additionally or alternatively, display/computing device 110 is tablet-sized computing device which includes a CPU, a computer readable memory and a computer readable storage medium, as further described with reference to FIG. 6. One or more program instructions are stored on computer readable storage medium for execution by CPU via computer readable memory. The one or more program instructions are operable to provide the functionality as described herein.

Referring to FIGS. 1 and 3, stand 120 provides support to display/computing device 110. Stand 120 includes a base 122 and a vertical or substantially vertical support 124. Base 120 can be of any desirable shape or configuration such as a square, rectangle, circle, oval, etc. Vertical or substantially vertical support 124 can be adjustable into different positions, and can be detachably attached to display/computing device 110. Attachment mechanism 126 is used to quickly and easily attach or detach display/computing device 110 from stand 120. The attachment mechanism 126 can be pins, screws, clamps, etc., as is known in the art such that no further explanation is required for a complete understanding of the present disclosure. Stand 120 can be composed of different materials such as plastic or metal or metal alloys, as examples.

Referring to FIGS. 1 and 4, incubator unit 130 communicates with display/computing device 110 through one of more ports 116 or through wireless communication connections. Incubator unit 130 is a modular component which can be replaced with a newer model should there by any functional issues with heating block(s) or should newer hardware be released. In this way, there is no need to replace display/computing device 110 or other modular components of system 100.

Incubator unit 130 includes a plurality of wells 132, which accommodate biological indicator ampules 134. Although eight (8) wells are shown, it is understood that any number of wells 132 are contemplated herein. For example, 10 wells can be provided in a single horizontal row. Wells 132 can also be aligned in different orientations such as two or more rows. Wells 132 can be heating blocks used for testing of biological material within biological indicator ampules 134.

Wells 130 include sensors 138 which are configured and structured to sense when biological indicator ampules 134 are inserted within any well 132. The sensor 138 can be a contact sensor or contactless sensor. For example, sensor 138 can be a switch that is depressed or a lever which is physically moved when inserting biological indicator ampules 134 within well 132. Alternatively, sensor 138 can be a light sensor, in which a beam of light is broken (will not be received by a receiver portion of the sensor) upon insertion of biological indicator ampules 134 within well 132. In any scenario, sensor 138 will indicate that biological indicator ampule 134 is inserted within a respective well 132. This information can be provided to display/computing device 110 for display on graphical user interface 112.

Still referring to FIGS. 1 and 4, incubator unit 130 includes a display 136. Display 136 can be an OLED, LCD, LED, AMOLED, QLED, plasma or ELD, amongst other types of displays. Display 136 is designed and configured to show a well number or other identifying feature of each well, aligned with each respective well 132. The well number or other identifying feature of each well 132 can also be displayed on graphical user interface 112, e.g., as insignia 114. Display 136 is also designed and configured to show which well 132 has a biological indicator 134 inserted therein and, additionally or alternative, to indicate a test result in front of each respective well 132 of a test performed on biological material within biological indicator ampule 134. Test result can be a color such as green (pass) and red (fail), or can be other insignia or notation. Test result will also be shown on graphical user interface 112, e.g., as insignia 114.

Referring now to FIG. 1, standalone reading system 140 is connected to display/computing device 110 by use of connection ports 116 or through wireless communication connections. Reading system 140 can be any known reading system. For example, reading system 140 can be a barcode scanner configured to read bar codes on biological indicator ampule 134. As should be understood by those of skill in the art, barcode scanner is an optical scanner that can read printed barcodes, decode the data contained in the barcode and send the data to a display/computing device 110. The decoded data contained in the barcode will be displayed on graphical user interface 112, e.g., as insignia 114.

FIG. 5 depicts a perspective view of biological indicator reader system 200 with a plurality of incubator units 130a, 130b, 130c connected to display/computing device 110. The incubator units 130a, 130b, 130c can communicate with display/computing device 110 through one of more ports 116 or through wireless communication connections. Incubator units 130a, 130b, 130c are modular components which can be added or removed from the system 200, as needed. In this way, the system 200 provides flexibility to add or remove components without having to replace the entire system allowing for scaling of the system 100.

The plurality of incubator units 130a, 130b, 130c can be connected to display/computing device 110 in a daisy chain configuration, or each separately to display/computing device 110. Each of the incubator units 130a, 130b, 130c include wells 132 and display 136 as described with respect to FIGS. 1 and 4. Display/computing device 110 and each incubator unit 130a, 130b, 130c will recognize that plural incubator units 130a, 130b, 130c are connected to display/computing device 110. In this way, graphical user interface 112 and display 136 can display and designate a consecutive number or letter or other identifying feature (e.g., insignia) for each of the wells 132 of each of the plural incubator units 130a, 130b, 130c.

For example, assuming each incubator unit 130a, 130b, 130c includes eight (8) wells 132, display 136 of incubator unit 130a will display numbers 1-8, display 136 for incubator unit 130b will display numbers 9-16 and display 136 of incubator unit 130c will display numbers 17-24. Similarly, graphical user interface 112 of display/computing device 110 will also display the consecutive numbering 1-24 or other identification methodology. Should any incubator unit be added or removed, displays 136 on each of the incubator units and the graphical user interface 112 of the display/computing device 110 will automatically be reconfigured to account for the addition or removal of the incubator units and number of wells 136, displaying a sequential number of each of the wells, in the order in which they are connected to the display/computing device 110. Accordingly, the biological indicator reader system 200 is easily reconfigurable for the addition or subtraction of incubator units and respective wells.

Moreover, displays 136 on each of the incubator units and the graphical user interface 112 of the display/computing device 110 will automatically display which wells 132 are occupied by biological indicator ampules 134. For example, in the case shown in FIG. 5, biological indicator ampules 134 are inserted into wells 1-6, 9-14 and 16-18. By using the sensor technology, the respective displays 136 on incubator units 130a, 130b, 130c and graphical user interface 112 of the display/computing device 110 can automatically display that wells 1-6, 9-14 and 16-18 are occupied. In addition, respective displays 136 on incubator units 130a, 130b, 130c and graphical user interface 112 of the display/computing device 110 will display which biological indicator ampules 134 have passed or failed the tests, for example.

FIG. 6 is an illustrative architecture of display/computing device 110. Display/computing device 110 is only one example of a suitable computing system and is not intended to suggest any limitation as to the scope of use or functionality thereof. Display/computing device 110 can be resident on a network infrastructure such as within a cloud environment, or may be a separate independent computing device (e.g., a computing device of a third party service provider). Display/computing device 110 may include a bus 610, a processor 615, a storage device 620, a system memory (hardware device) 625, one or more input devices 630, one or more output devices 635, and a communication interface 640.

Bus 610 permits communication among the components of display/computing device 110. Processor 615 may be one or more conventional processors or microprocessors that is operative to interpret and execute computer readable program instructions, such as program instructions for controlling the operation and performance of one or more of the various components of display/computing device 110 and components 130, 140. Processor 615 interprets and executes the processes, steps, functions, and/or operations, which may be operatively implemented by the computer readable program instructions. Processor 615 may receive input signals from one or more input devices 630 and/or drive output signals through one or more output devices 635. Input devices 630 may be, e.g., graphical user interface 112, reading system 140 or incubator units 130 shown in FIG. 1. The output devices 635 can be, for example, any display device, e.g., graphical user interface 112, printer, etc.

Storage device 620 may include removable/non-removable, volatile/non-volatile computer readable media, such as, but not limited to, non-transitory media. The computer readable media provides for storage of computer readable program instructions for operation of biological indicator reader system 100. Storage device 620 may store operating system 645, application programs 650, and program data 655. System memory 625 may include one or more storage mediums, including for example, non-transitory media of any known kind, including RAM and ROM. Communication interface 640 may include any transceiver-like mechanism (e.g., a network interface, a network adapter, a modem, or combinations thereof) that enables display/computing device 110 to communicate with remote devices or systems, such as a mobile device or other computing devices such as, for example, a server in a networked environment, e.g., cloud environment, or any other components of biological indicator reader system 100.

Display/computing device 110 performs tasks (e.g., process, steps, methods and/or functionality) in response to processor 615 executing program instructions contained in a computer readable medium, such as system memory 625. The program instructions may be read into system memory 625 from another computer readable medium, such as data storage device 620, or from another device via the communication interface 640 or server within or outside of a cloud environment.

By virtue of the different aspects of the present disclosure illustrated and described herein, methods of using the biological indicator reader system are set forth herein. These methods can be implemented on or with use of display/computing device 110. For example, the method includes connecting reading system 140 and one or more incubator units 130 to display/computing device 110 used with biological indicator reader system 100. Display/computing device 110 recognizes the number of incubator units communicating with the display/computing device 110, in which case the graphical user interface 112 will display identification information of each number of wells connected to the display/computing device 110. Moreover, display 136 of each of the incubator units will recognize the number of wells and display identification information of each of the wells. The displayed identification information is preferably a sequential number for each of the wells, in the order in which they are connected to the display/computing device 110.

An operator provides additional information by entering such information to the display/computing device 110. This additional information may include name of operator, location, etc. In addition, the operator will scan or read one or more biological indicator ampules using reading system 140, at which time graphical user interface 112 will display identification information of the biological indicator ampules 134. The operator will insert the biological indicator ampules into the wells 132, at which time the sensors will recognize such insertion of the biological indicator ampules 134 into the specific wells 132. The information will then be related to both display 136 of each incubator unit 130 and graphical user interface 112. The display 136 of each incubator unit and graphical user interface 112 will display identification information of inserted ampules within a respective well. Thereafter, a test on each of the ampules will be performed, at which time test results can be displayed on the graphical user interface 112. Should any additional incubator units be added or deleted, the displays 112, 136 will automatically be reconfigured as already described herein.

Any of the examples or embodiments described herein may include various other features in addition to or in lieu of those described above. The teachings, expressions, embodiments, examples, etc., described herein should not be viewed in isolation relative to each other. Various suitable ways in which the teachings herein may be combined should be clear to those skilled in the art in view of the teachings herein.

Having shown and described exemplary embodiments of the subject matter contained herein, further adaptations of the methods and systems described herein may be accomplished by appropriate modifications without departing from the scope of the claims. In addition, where methods and steps described above indicate certain events occurring in certain order, it is intended that certain steps do not have to be performed in the order described but in any order as long as the steps allow the embodiments to function for their intended purposes. Therefore, to the extent there are variations of the invention, which are within the spirit of the disclosure or equivalent to the inventions found in the claims, it is the intent that this patent will cover those variations as well. Some such modifications should be apparent to those skilled in the art. For instance, the examples, embodiments, geometrics, materials, dimensions, ratios, steps, and the like discussed above are illustrative. Accordingly, the claims should not be limited to the specific details of structure and operation set forth in the written description and drawings.

1. A biological indicator reader system, comprising:
a standalone computing device comprising a graphical user interface;
a standalone reading system communicating with the standalone computing device; and
a plurality of incubator units, each incubator unit comprising a plurality of wells that accommodate vials, and each incubator unit comprising a display that is configured to display information that is also displayed on the graphical user interface of the standalone computing device.

2. The biological indicator reader system of claim 1, in which the information includes:
(i) identification of a number of wells of the plurality of incubator units connected to the standalone computing device;
(ii) sequential numbering system that identifies the number of wells of the plurality of incubator units connected to the standalone computing device;
(iii) numbers, letters, alphanumerical codes, or colors that represent the vials placed in respective wells of the plurality of incubator units: or
(iv) includes user name, test results of biological matter, identification of the vials as read by the standalone reading system.

3-5. (canceled)

6. The biological indicator reader system of any claim 1, in which the standalone computing device includes a plurality of connection ports to connect the graphical user interface to the plurality of incubator units and the standalone reading system.

7. The biological indicator reader system of claim 1, in which the standalone reading system comprises a barcode reader.

8. The biological indicator reader system of claim 1, in which the plurality of incubator units are connected to the standalone computing device through one of more ports or through a wireless communication connection.

9. The biological indicator reader system of claim 1, in which the wells of the plurality of incubator units comprise heating blocks.

10. The biological indicator reader system of claim 1, further comprising sensors associated with each of the wells of the plurality of incubator units, the sensors being configured to determine that the vials are inserted into the wells.

11. The biological indicator reader system of claim 0, in which the sensors comprise contact sensors or non-contact sensors.

12. (canceled)

13. The biological indicator reader system of claim 1, in which the display is configured to show which well has a vial inserted therein and, additionally or alternatively, to indicate a test result in front of each respective well of a test performed on the vial.

14. The biological indicator reader system of claim 1, in which the graphical user interface displays the number of wells in the plurality of incubator units or a test result conducted on the vial inserted into the wells.

15. (canceled)

16. The biological indicator reader system of claim 14, in which the plurality of incubator units comprise modular components.

17. The biological indicator reader system of claim 1, in which the plurality of incubator units are connected in a daisy chain configuration.

18. The biological indicator reader system of claim 1, in which the plurality of incubator units are connected separately to the computing device.

19-30. (canceled)

31. A biological indicator reader system, comprising:
a standalone computing device comprising a graphical user interface;
a standalone reading system communicating with the standalone computing device; and
a plurality of incubator units, each incubator unit comprising a plurality of wells that accommodate vials, and each incubator unit comprising a display that is configured to display information that is also displayed on the graphical user interface of the standalone computing device,
wherein each of the plurality of incubator units and the standalone computing device recognize a number of wells connected to the standalone computing device.

32. The biological indicator reader system of claim 31, in which each display of the plurality of incubator units and the graphical user interface of the standalone computing device displays information of each of the wells recognized by the plurality of incubator units and the standalone computing device.

33. The biological indicator reader system of claim 31, in which the graphical user interface of the computing device displays sequential numbers of each of the wells recognized as being connected to the standalone computing device.

34. The biological indicator reader system of claim 31, in which the graphical user interface of the standalone computing device and the display of each of the plurality of incubator units automatically displays which wells are occupied by the vials.

35. The biological indicator reader system of claim 31, in which the graphical user interface of the standalone computing device automatically displays which vials passed or failed a test performed on material within the vials.

36. A system comprising:
a plurality of vials; and
a biological indicator reader system, comprising:
a standalone computing device comprising a graphical user interface;
a standalone reading system communicating with the standalone computing device; and
a plurality of incubator units, each incubator unit comprising a plurality of wells that accommodate the vials, and each incubator unit comprising a display that is configured to display information that is also displayed on the graphical user interface of the standalone computing device.
